(19) United States
(12) Patent Application Publication
(10) Pub. No.: US 2021/0384570 A1
(43) Pub. Date: Dec. 9, 2021

(54) COOLER

(71) Applicant: TOYOTA JIDOSHA KABUSHIKI KAISHA, Aichi-ken (JP)

(72) Inventor: Satoko TOFUKUJI, Minato-ku (JP)

(21) Appl. No.: 17/337,420

(22) Filed: Jun. 3, 2021

(30) Foreign Application Priority Data
Jun. 5, 2020 (JP) 2020-098864

(51) Int. Cl. H01M 10/6556; H01M 50/209; H01M 50/249; H01M 10/613; H01M 10/625; H01M 10/647; H01M 10/6569; H01M 10/6554

(52) U.S. Cl. CPC H01M 10/6556; H01M 50/209; H01M 50/249; H01M 10/613; H01M 2220/20; H01M 10/647; H01M 10/6569; H01M 10/6554; H01M 10/625

(57) ABSTRACT

A cooler that cools a battery stack in which a plurality of battery cells are stacked, includes: a first plate members that is in surface contact with a side surface of the battery cells; a second plate members that prevents the battery cells from being moved; and a refrigerant flow path formed between those plate members and through which a refrigerant flows. Further, the second plate member has a flat plate-shaped side surface portion, and the battery cells arranged at both ends in the stacking direction among the plurality of battery cells or end plates arranged at both ends in the stacking direction of the battery stack are fixed to the second plate member.

### CROSS-REFERENCE TO RELATED APPLICATION(S)

The present application claims priority to and incorporates by reference the entire contents of Japanese Patent Application No. 2020-098864 filed in Japan on Jun. 5, 2020.

### BACKGROUND

The present disclosure relates to a cooler.

International Publication No. WO2018/070115 discloses a cooler for cooling a battery stack in which a plurality of battery cells are stacked. The cooler includes a first plate member and a second plate member, and the first plate member is placed in surface contact with a side surface of the battery cell. Further, in the cooler, a refrigerant flow path through which a refrigerant for cooling the battery cell flows is formed between the first plate member and the second plate member.

By the way, since a plurality of battery cells are stacked in the battery stack, it is known that the battery stack is restrained by a restraining member so as to restrict movement of the battery cells in a stacking direction. In a configuration described in International Publication No. WO2018/070115, it is necessary to provide the restraining member separately from the cooler. Therefore, the number of parts increases.

Therefore, it is conceivable to restrain the battery stack by the cooler. In this case, the cooler receives a force for the battery cells to expand in the stacking direction (hereinafter referred to as a restraining force). Therefore, it is conceivable that a plate member constituting the cooler has rigidity against the restraining force. In the configuration described in International Publication No. WO2018/070115, since the first plate member is placed at a position closer to the battery cell than the second plate member, it is conceivable that the battery stack is restrained by the first plate member. However, if a plate thickness of the first plate member is increased in order to increase the rigidity, thermal resistance of the first plate member increases in a transmission path between the refrigerant and the battery cell, and cooling efficiency may decrease.

### SUMMARY

There is a need for providing a cooler capable of restraining the battery stack while ensuring cooling performance of the battery cell.

According to an embodiment, a cooler that cools a battery stack in which a plurality of battery cells are stacked, includes: a first plate members that is in surface contact with a side surface of the battery cells, the side surface facing a width direction orthogonal to a stacking direction of the battery cells, among surfaces of the battery cells; a second plate members that is integrated with the first plate member and restrains the battery stack so as to prevent the battery cells from being moved in the stacking direction; and a refrigerant flow path formed between the first plate member and the second plate member and through which a refrigerant for cooling the battery cells flows. Further, the second plate member has a flat plate-shaped side surface portion extending in the stacking direction and extending in a vertical direction orthogonal to the stacking direction, and the battery cells arranged at both ends in the stacking direction among the plurality of battery cells or end plates arranged at both ends in the stacking direction of the battery stack are fixed to the second plate member.

### BRIEF DESCRIPTION OF THE DRAWINGS

FIG. 1 is a perspective view schematically illustrating an overall structure of a battery unit including a cooler in an embodiment;

FIG. 2 is a cross-sectional view illustrating a cross section taken along a line A-A of FIG. 1;

FIG. 3 is a cross-sectional view illustrating a cross section taken along a line B-B of FIG. 1;

FIG. 4 is a side view illustrating the battery unit viewed from the right side in a width direction thereof;

FIG. 5 is a cross-sectional view illustrating a cross section taken along a line C-C of FIG. 4;

FIG. 6 is an enlarged schematic view of a portion surrounded by a broken line in FIG. 5;

FIG. 7 is a perspective view schematically illustrating an external structure of the cooler;

FIG. 8 is a perspective view illustrating a shape in which the cooler is cut along a line D-D of FIG. 7;

FIG. 9 is a cross-sectional view illustrating a cross section taken along the line D-D of FIG. 7;

FIG. 10 is a perspective view illustrating a shape in which the cooler is cut along a line E-E of FIG. 7;

FIG. 11 is a cross-sectional view illustrating a cross section taken along the line E-E of FIG. 7;

FIG. 12 is a perspective view schematically illustrating the external structure of the cooler;

FIG. 13 is a perspective view illustrating a shape in which the cooler is cut along a line F-F of FIG. 12;

FIG. 14 is a perspective view illustrating a shape in which the cooler is cut along a line G-G of FIG. 12;

FIG. 15 is a diagram for explaining a restraining force acting on a side surface portion of a second plate member; and

FIG. 16 is a diagram for explaining a restraining force acting on a member having irregularities in a stacking direction thereof as a comparative example.

### DETAILED DESCRIPTION

Hereinafter, a cooler according to an embodiment of the present disclosure will be specifically described with reference to the drawings. The present disclosure is not limited to the embodiments described below.

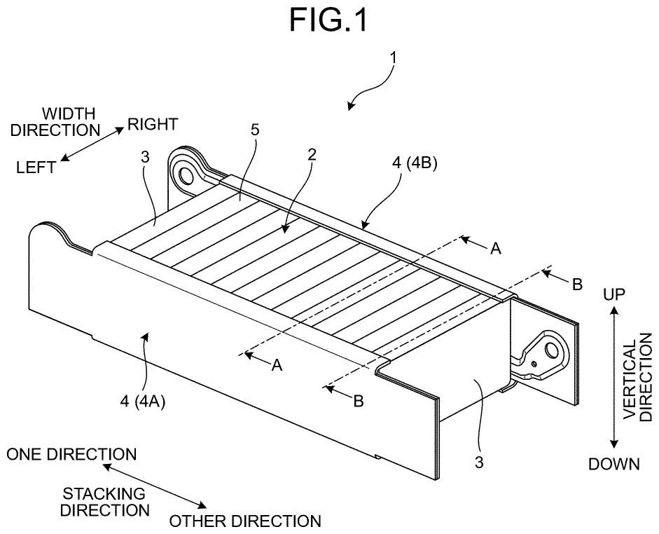

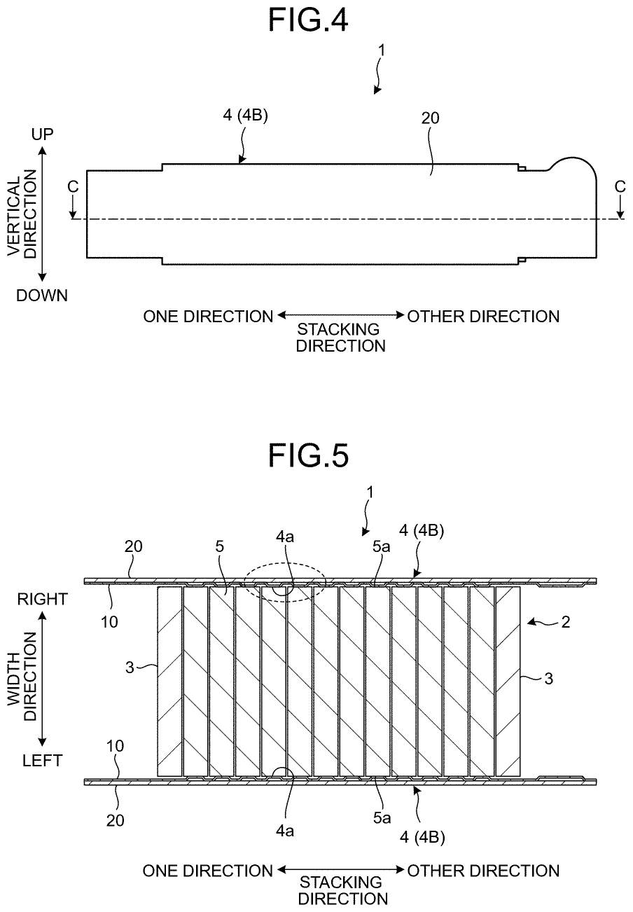

As illustrated in FIG. 1, a battery unit 1 of the present embodiment includes a battery stack 2, an end plate 3, and a cooler 4. The battery stack 2 has a structure in which a plurality of battery cells 5 are stacked. In the battery unit 1, as illustrated in FIGS. 1 to 5, a pair of end plates 3 are arranged on both sides in a stacking direction of the battery cells 5 with respect to one battery stack 2, and a pair of coolers 4 are arranged on both sides in a width direction of the battery cells 5. For example, the battery unit 1 is mounted on an electric vehicle (EV) or a plug-in hybrid vehicle (PHV).

When explaining an arrangement of constituent members of the battery unit 1, the stacking direction, the width direction, and a vertical direction are used. The stacking direction is the stacking direction of the battery cells 5 and coincides with a thickness direction of the battery cells 5. The width direction is a direction orthogonal to the stacking direction and coincides with the width direction of the battery cells 5. The vertical direction is a direction orthogonal to the stacking direction and the width direction, and coincides with a height direction of the battery cells 5. When the vehicle equipped with the battery unit 1 is kept horizontal, the stacking direction and the width direction are horizontal, and the vertical direction is vertical.

The battery stack 2 is formed by stacking the plurality of battery cells 5 and forming a substantially rectangular parallelepiped shape as a whole. In an example illustrated in FIG. 1, the battery stack 2 includes a total of 12 battery cells 5.

For example, the battery stack 2 is an in-vehicle battery that stores electric power for supplying a running motor. Heat is generated in the battery cell 5 with energization during discharging to supply the electric power to the running motor, such as when the vehicle is running, or during charging from an external power source such as a charging stand. This heated battery cell 5 is cooled by the cooler 4.

The battery cell 5 is a secondary battery and includes a positive electrode terminal and a negative electrode terminal. In the battery stack 2, the terminals of the battery cell 5 are electrically connected to each other. Further, as illustrated in FIGS. 1 to 3, the battery cell 5 has a shape (wide shape) in which a dimension in the width direction is greater than that in the vertical direction. The battery cell 5 has a predetermined thickness in the stacking direction, and has a substantially rectangular parallelepiped shape as a whole.

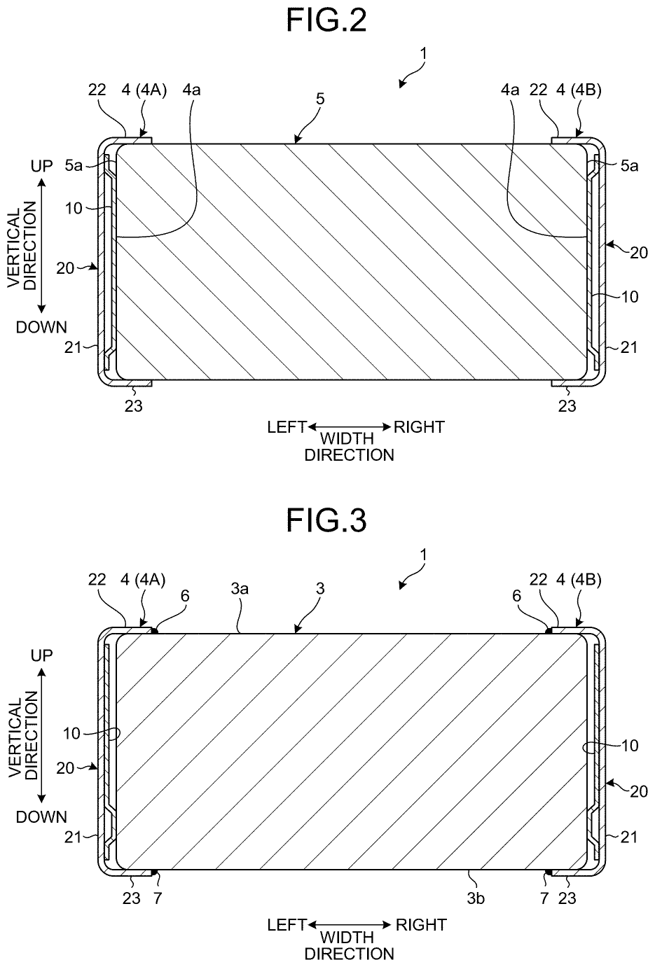

As illustrated in FIGS. 2 and 5, a side surface 5a of the battery cell 5 is in surface contact with a heat receiving surface 4a of the cooler 4. That is, the side surface 5a is a heat dissipation surface (heat exchange surface) that dissipates the heat of the battery cell 5 to the cooler 4. The side surface 5a is a plane extending in the stacking direction and the vertical direction, and the dimension in the vertical direction is formed to be greater than that in the stacking direction. Further, the side surface 5a is a surface facing the width direction orthogonal to the stacking direction out of the surfaces of the battery cell 5.

The end plates 3 are arranged at both ends of the battery stack 2 in the stacking direction to restrict the battery cells 5 from moving in the stacking direction. As illustrated in FIG. 1, the pair of end plates 3 are arranged at both ends in the stacking direction so as to sandwich the plurality of battery cells 5, and face a ventral surface (a surface facing the stacking direction) of the battery cells 5. The end plate 3 has a dimension in the width direction greater than that in the vertical direction, has a predetermined thickness in the stacking direction, and has a substantially rectangular parallelepiped shape as a whole.

The end plate 3 is fixed to a flange portion (an upper flange portion 22 and a lower flange portion 23 to be described below) of the cooler 4. The end plate 3 restrains the battery stack 2 while being held by the cooler 4. That is, in the present embodiment, the cooler 4 in addition to the end plate 3 functions as a member that restrains the battery stack 2 so as to restrict the plurality of battery cells 5 from moving in the stacking direction.

The cooler 4 cools the battery cells 5 with a refrigerant flowing in a refrigerant flow path. As illustrated in FIG. 1, the cooler 4 includes a first cooler 4A and a second cooler 4B.

The first cooler 4A is placed on the left side in the width direction of the battery stack 2, and is in surface contact with the side surface 5a of the battery cell 5 as illustrated in FIG. 2. The second cooler 4B is placed on the right side in the width direction of the battery stack 2, and is in surface contact with the side surface 5a of the battery cell 5 as illustrated in FIG. 2. For example, the first cooler 4A and the second cooler 4B are configured to have a symmetrical structure in the width direction.

As illustrated in FIG. 1, the end plates 3 are fixed to both ends in the width direction of the first cooler 4A and the second cooler 4B. That is, the first cooler 4A and the second cooler 4B have a cooling function for cooling the battery cells 5 and a restraining function for restraining the plurality of battery cells 5. The restraint function is a function of restraining the plurality of battery cells 5 so as to restrict the plurality of battery cells 5 included in the battery stack 2 from moving in the stacking direction. In this description, when the first cooler 4A and the second cooler 4B are not particularly discriminated, they are simply described as the cooler 4.

For example, the cooler 4 includes an evaporator included in a loop type thermosiphon. In the loop type thermosiphon, the heat to be cooled is transported by using a working fluid that changes phase between a liquid phase and a gas phase. The working fluid absorbs or dissipates the heat by utilizing latent heat when it is vaporized or liquefied. In the case of a boiling cooling type cooler 4, the refrigerant includes the working fluid that is vaporized or liquefied.

The loop type thermosiphon includes the evaporator, a condenser, a vapor passage through which the working fluid in the gas phase flows, and a liquid passage through which the working fluid in the liquid phase flows. In the loop type thermosiphon, the working fluid is enclosed in a closed loop circuit, and the working fluid circulates between the evaporator and the condenser. A steam passage is laid to connect a steam outlet of the evaporator and a steam inlet of the condenser. A liquid passage is laid to connect a liquid outlet of the condenser and a liquid inlet of the evaporator.

Here, the structure of the cooler 4 will be described in more detail.

The cooler 4 includes two press-molded plate members. As illustrated in FIG. 2, the cooler 4 has a first plate member 10 and a second plate member 20.

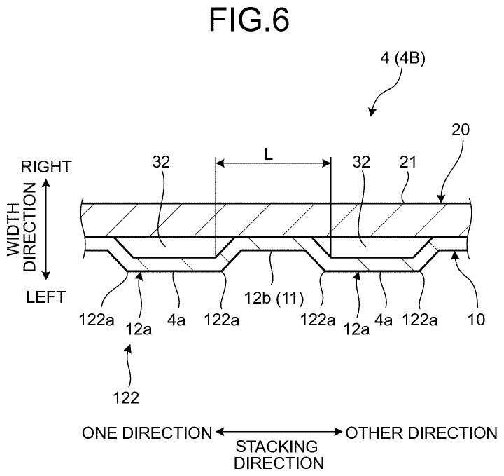

The first plate member 10 is made of a press-molded plate member, and constitutes a heat receiving portion that is in surface contact with the side surface 5a of the battery cell 5 and receives the heat of the battery cell 5. As illustrated in FIG. 6, the first plate member 10 has a flat plate portion 11 and a flow path forming portion 12.

The flat plate portion 11 is a portion to be joined to the second plate member 20. The flat plate portion 11 is formed in a flat plate shape in the stacking direction and the vertical direction. In the cooler 4, as illustrated in FIGS. 5 and 6, the first plate member 10 is joined in a state of being laminated on the second plate member 20. Further, a plate thickness of the first plate member 10 is thinner than that of the second plate member 20. That is, the plate thickness of the flow path forming portion 12 is formed thin.

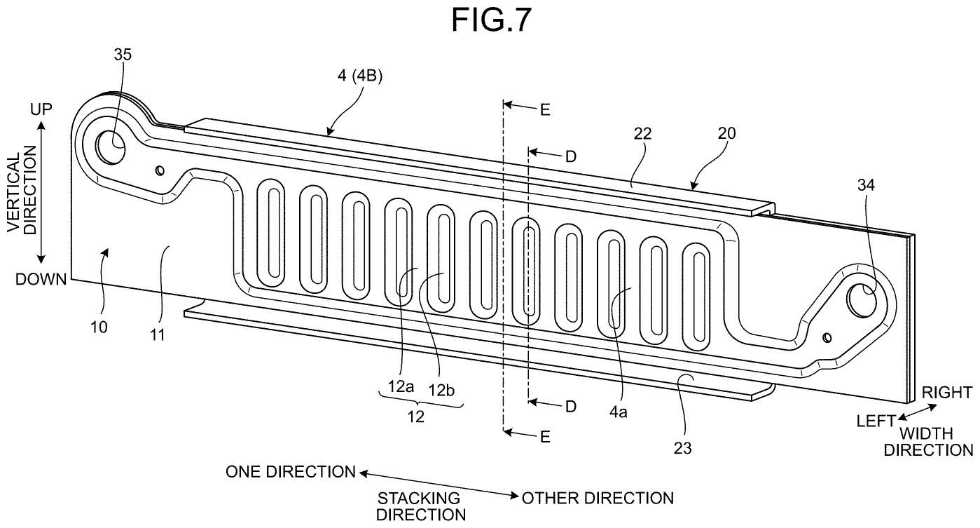

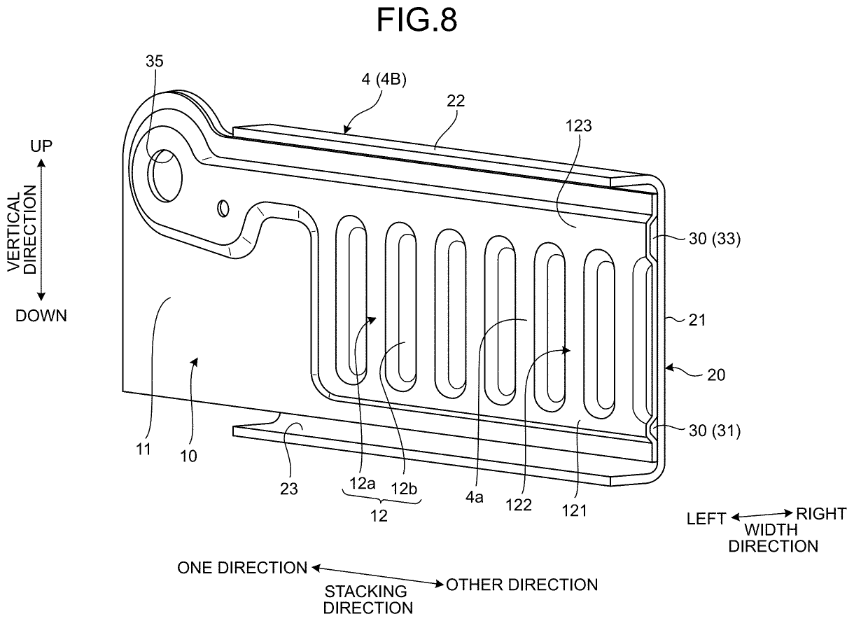

The flow path forming portion 12 is a portion that forms a refrigerant flow path 30 through which the refrigerant flows. As illustrated in FIGS. 7 to 8, the refrigerant flow path 30 through which the refrigerant flows is formed inside the cooler 4. Detailed configuration of the refrigerant flow path 30 will be described below.

As illustrated in FIG. 7, the flow path forming portion 12 is configured to include a convex portion 12a protruding from the flat plate portion 11 toward the battery cell 5. Then, as illustrated in FIGS. 5 to 8, the flow path forming portion 12 has a shape in which the convex portions 12a and concave portions 12b are alternately provided in the stacking direction at a position in the middle in the vertical direction in a portion facing a side surface of the battery stack 2. The concave portion 12b is formed in the same shape as the flat plate portion 11. That is, in the first plate member 10, when the flat plate portion 11 is press-molded to form the convex portion 12a, a portion of the flat plate portion 11 that remains without being pressed between the convex portion 12a and the convex portion 12a is the concave portion 12b.

The flow path forming portion 12 forms a heat receiving surface 4a that is in surface contact with the side surface 5a of the battery cell 5. The heat receiving surface 4a is a surface formed by the convex portion 12a.

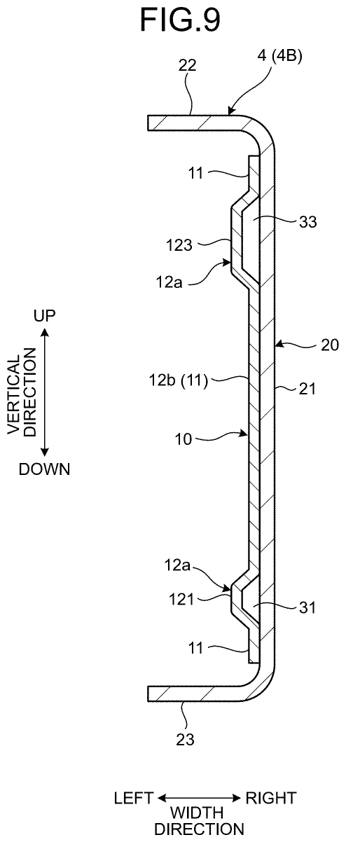

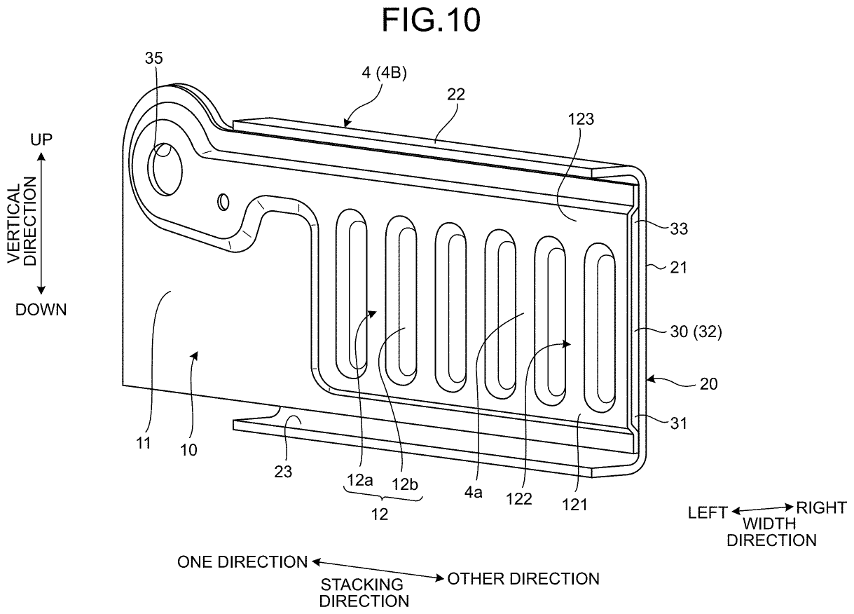

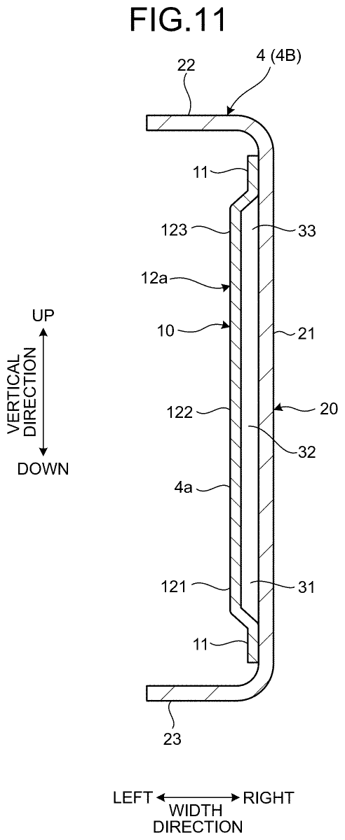

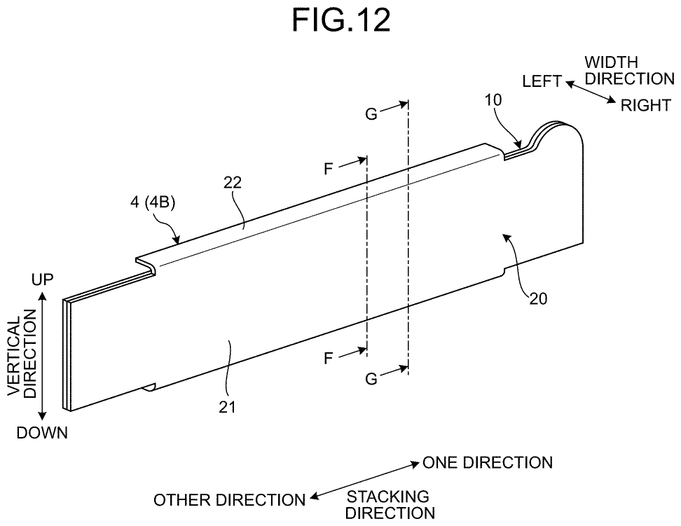

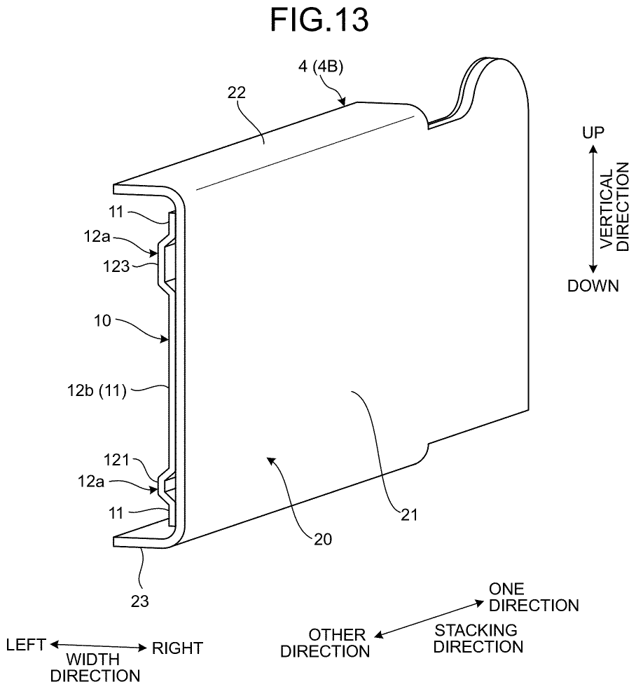

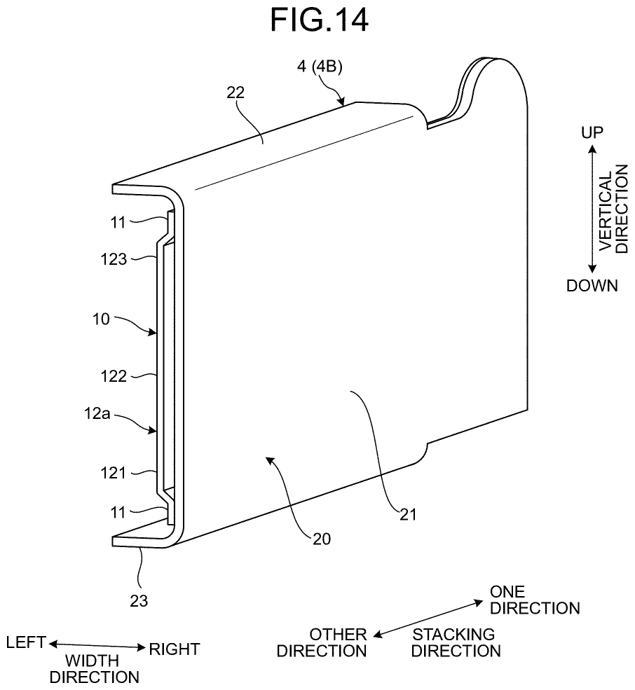

The second plate member 20 is made of a press-molded plate member, and constitutes a fixing portion to which the end plate 3 is fixed and a restraining portion for restraining the battery stack 2. As illustrated in FIGS. 5 to 9, the second plate member 20 has a side surface portion 21, an upper flange portion 22, and a lower flange portion 23.

The side surface portion 21 is a portion forming a side surface of the cooler 4. The side surface portion 21 is formed in a flat plate shape in the stacking direction and the vertical direction. Then, the flat plate portion 11 is joined to the side surface portion 21 in a surface contact state. For example, an edge portion of the flat plate portion 11 and an edge portion of the side surface portion 21 are welded together. That is, in the cooler 4, the first plate member 10 and the second plate member 20 are integrated by laminating and joining the flat plate portion 11 on the side surface portion 21. A welded portion between the flat plate portion 11 and the side surface portion 21 is not illustrated.

The upper flange portion 22 is a portion where an upper surface 3a of the end plate 3 is fixed. As illustrated in FIGS. 2 and 3, the upper flange portion 22 is placed to face the upper surface 3a of the end plate 3 and an upper surface 5b of the battery cell 5 in the vertical direction. Further, as illustrated in FIGS. 1 and 6, the upper flange portion 22 extends in the stacking direction so as to include the battery stack 2 and the end plate 3.

The end plate 3 is fixed to the upper flange portion 22. As illustrated in FIG. 3, the upper surface 3a of the end plate 3 is joined to the upper flange portion 22 by a welded portion 6. The welded portion 6 is formed by laser welding or the like. For example, a tip portion of the upper flange portion 22 and the upper surface 3a are welded together. Thus, the upper flange portion 22 restricts the battery cell 5 from moving in the stacking direction.

In the present embodiment, the battery cell 5 is not joined to the upper flange portion 22. That is, the upper flange portion 22 restricts the battery cell 5 from moving upward in the vertical direction in a state where it is not joined to the battery cell 5.

The lower flange portion 23 is a portion where a lower surface 3b of the end plate 3 is fixed. As illustrated in FIGS. 2 and 3, the lower flange portion 23 is placed to face the lower surface 3b of the end plate 3 and a lower surface 5c of the battery cell 5 in the vertical direction. Further, as illustrated in FIG. 6, the lower flange portion 23 extends in the stacking direction so as to include the battery stack 2 and the end plate 3.

The end plate 3 is fixed to the lower flange portion 23. As illustrated in FIG. 3, the lower surface 3b of the end plate 3 is joined to the lower flange portion 23 by a welded portion 7. The welded portion 7 is formed by laser welding or the like. For example, a tip portion of the lower flange portion 23 and the lower surface 3b are welded together. Thus, the lower flange portion 23 restricts the battery cell 5 from moving in the stacking direction.

In the present embodiment, the battery cell 5 is not joined to the lower flange portion 23. That is, the lower flange portion 23 restricts the battery cell 5 from moving downward in the vertical direction in a state where it is not joined to the battery cell 5.

Here, the detailed configuration of the refrigerant flow path 30 will be described. The refrigerant flow path 30 includes an internal space formed between the first plate member 10 and the second plate member 20.

As illustrated in FIGS. 7 and 8, the refrigerant flow path 30 has a supply flow path 31, an evaporation flow path 32, and an outflow flow path 33. The supply flow path 31 is a flow path to which the working fluid in the liquid phase is supplied. The evaporation flow path 32 is a flow path through which the working fluid in the liquid phase evaporates. The outflow flow path 33 is a flow path through which the working fluid in the gas phase flows out. Further, the flow path forming portion 12 includes a first forming portion 121 forming the supply flow path 31, a second forming portion 122 forming the evaporation flow path 32, and a third forming portion 123 forming the outflow flow path 33. In the refrigerant flow path 30, the supply flow path 31, the evaporation flow path 32, and the outflow flow path 33 communicate in this order from upstream to downstream.

As illustrated in FIG. 8, the first forming portion 121 and the supply flow path 31 are provided on a lower side of the cooler 4 in the vertical direction and extend in the stacking direction. For example, the first forming portion 121 extends in the stacking direction so as to include a length in the stacking direction of the battery stack 2.

Further, the first forming portion 121 is provided with an inflow port 34 of the refrigerant. An upstream side of the supply flow path 31 communicates with the inflow port 34. The refrigerant supplied to an inside of the cooler 4 flows into the inflow port 34. In the loop type thermosiphon, the working fluid in the liquid phase condensed in the condenser flows to the inflow port 34 by gravity. Then, the working fluid in the liquid phase flowing in from the inflow port 34 is supplied to the supply flow path 31. A downstream side of the supply flow path 31 communicates with the evaporation flow path 32.

As illustrated in FIG. 8, the second forming portion 122 and the evaporation flow path 32 extend in the vertical direction. In the evaporation flow path 32, a lower side in the vertical direction is an upstream side, and an upper side in the vertical direction is a downstream side. The downstream side of the evaporation flow path 32 communicates with the outflow flow path 33. That is, the refrigerant flows through the evaporation flow path 32 from the lower side to the upper side in the vertical direction.

A surface of the second forming portion 122 (A surface on the battery cell 5 side in the width direction) forms a heat receiving surface 4a. As illustrated in FIG. 6, the heat receiving surface 4a is formed in a substantially rectangular shape in which a dimension in the vertical direction is greater than that in the stacking direction.

For example, in the case of the boiling cooling type, the working fluid in the liquid phase is supplied to an inside of the evaporation flow path 32 up to a predetermined height in the vertical direction. That is, inside the evaporation flow path 32, the working fluid in the liquid phase is present on the lower side in the vertical direction, and the working fluid in the gas phase is present on the upper side in the vertical direction. Then, when the working fluid in the liquid phase present inside the evaporation flow path 32 receives the heat from the battery cell 5 via the heat receiving surface 4a, it is vaporized by the heat. When the working fluid in the liquid phase is vaporized, the working fluid in the gas phase flows upward in the evaporation flow path 32 and flows into the outflow flow path 33.

As illustrated in FIG. 8, the third forming portion 123 and the outflow flow path 33 are provided on the upper side of the cooler 4 in the vertical direction and extend in the stacking direction. The third forming portion 123 extends in the stacking direction so as to include the length in the stacking direction of the battery stack 2.

The third forming portion 123 is provided with an outflow port 35 of the refrigerant. The downstream side of the outflow flow path 33 communicates with the outflow port 35. The refrigerant heat-exchanged by the cooler 4 flows out from the outflow port 35. In the loop type thermosiphon, the working fluid in the gas phase vaporized by the cooler 4 which is the evaporator flows out from the outflow port 35. In a circulation circuit of the refrigerant, the working fluid in the gas phase flowing out from the outflow port 35 is supplied to the condenser. The condenser is placed above the cooler 4 in the vertical direction.

As described above, according to the embodiment, the cooler 4 can restrain the battery stack 2 and cool the battery cell 5. Thus, the number of parts of the battery unit 1 can be reduced.

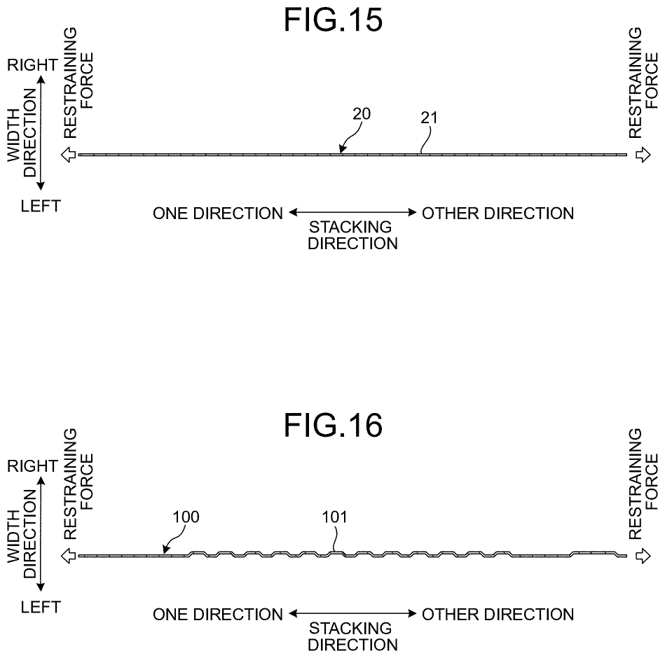

In the cooler 4, the second plate member 20 can receive a force (restraining force) that the battery cell 5 tries to expand. As illustrated in FIG. 15, the second plate member 20 is formed in a flat plate shape having no irregularities in an action direction of the restraining force. Therefore, since the restraining force can be received by the side surface portion 21, there is no portion where stress is concentrated in the second plate member 20. Thus, a required plate thickness of the second plate member 20 can be reduced as compared with a plate member having irregularities in the action direction of the restraining force. For example, as illustrated in FIG. 16, when a plate member 100 having irregularities in the stacking direction receives the restraining force, since the stress is applied to an irregular portion 101 in a direction in which the restraining force acts (stretching direction), it is necessary to increase the plate thickness in order to increase rigidity. On the other hand, as illustrated in FIG. 15, when the second plate member 20 having no irregularities receives the restraining force, since there is no portion where the stress is concentrated, it is not necessary to increase the plate thickness in order to increase the rigidity, and the plate thickness can be thinned. Thus, a weight of the cooler 4 can be reduced.

Since the first plate member 10 does not receive the restraining force, the plate thickness can be reduced. If the plate thickness of the first plate member 10 can be reduced, not only the weight can be reduced, but also thermal resistance between the first plate member 10 and the battery cell 5 can be reduced. That is, the thermal resistance of the first plate member 10 can be reduced in a heat transfer path between the refrigerant and the battery cell 5. Thus, cooling performance of the battery cell 5 of the cooler 4 can be improved. Further, since heat capacity of the first plate member 10 can also be reduced, cooling of the battery cell 5 can be started earlier when circulation of the working fluid in the loop type thermosiphon is started.

Further, since the plate thickness of the first plate member 10 can be reduced, a bending radius (also referred to as a bending R) of the convex portion 12a in the flow path forming portion 12 can be reduced. The bending radius of the convex portion 12a is a bending radius with respect to the stacking direction, and is roundness inside a bending portion in the second forming portion 122. If the bending radius of the convex portion 12a can be reduced, an R portion 122a outside the bending portion in the second forming portion 122 can be reduced. Therefore, an area (a heat exchange area) of the heat receiving surface 4a that comes into surface contact with the side surface 5a of the battery cell 5 can be increased. Thus, cooling efficiency of the battery cell 5 is further improved. As illustrated in FIG. 6, as the bending radius of the convex portion 12a is smaller, a dimension L in the stacking direction between the convex portion 12a and the convex portion 12a can be reduced, so that the area of the heat receiving surface 4a, which is a cooling area, can be increased.

The present disclosure is not limited to the above-described embodiment, and can be appropriately modified without departing from the object of the present disclosure.

For example, the cooler 4 is not limited to the boiling cooling type, and may be a cooler provided in the circulation circuit in which the coolant circulates in the flow path.

Further, a method of fixing the upper flange portion 22 to the end plate 3 and a method of fixing the lower flange portion 23 to the end plate 3 are not limited to welding, and may be mechanical fastening such as rivets or bolts.

The battery unit 1 may have a structure that does not include the end plate 3. That is, it may be configured such that a pair of battery cells arranged at both ends in the stacking direction out of the plurality of battery cells 5 are fixed to the second plate member 20 of the cooler 4. In this case, the upper surfaces of the pair of battery cells are joined to the upper flange portion 22. Similarly, the lower surfaces of the pair of battery cells are joined to the lower flange portion 23. That is, the pair of battery cells fixed to the upper flange portion 22 and the lower flange portion 23 are arranged at both ends of the battery stack 2 in the stacking direction, and restrict the battery cells 5 from moving in the stacking direction. The pair of battery cells restrain the battery stack 2 while being held by the cooler 4. The battery cells other than the pair of battery cells out of the battery cells 5 constituting the battery stack 2 are not fixed to the second plate member 20. A method of fixing the pair of battery cells to the upper flange portion 22 and a method of fixing the pair of battery cells to the lower flange portion 23 are not limited to welding, but may be mechanical fastening such as rivets or bolts.

Further, the upper flange portion 22 and the lower flange portion 23 are not limited to a shape extending in a series in the stacking direction, and may have a shape in which a cutout portion is partially provided. For example, the upper flange portion 22 and the lower flange portion 23 may be provided with the cutout portion at a boundary portion between the battery cell 5 and the battery cell 5 in the stacking direction.

In the present disclosure, the battery stack can be restrained by the cooler by fixing the battery cell or the end plate to the second plate member constituting the cooler. Further, since the second plate member has a side surface portion extending in a stacking direction thereof, stress concentration is unlikely to occur on the side surface portion when the battery cell receives a force to move in the stacking direction. Therefore, the first plate member integrated with the second plate member can be configured to have a structure capable of exhibiting the cooling performance of the battery cell, and the cooling performance of the battery cell by the cooler can be ensured.

According to an embodiment, the battery stack can be restrained by the cooler by fixing the battery cell or the end plate to the second plate member constituting the cooler. Further, since the second plate member has a side surface portion extending in a stacking direction thereof, stress concentration is unlikely to occur on the side surface portion when the battery cell receives a force to move in the stacking direction. Therefore, the first plate member integrated with the second plate member can be configured to have a structure capable of exhibiting the cooling performance of the battery cell, and the cooling performance of the battery cell by the cooler can be ensured.

According to an embodiment, the battery cell or the end plate can be fixed to the upper flange portion and the lower flange portion provided on the second plate member.

According to an embodiment, since the plate thickness of the first plate member forming the refrigerant flow path is thinner than that of the second plate member, the thermal resistance when the refrigerant receives heat of the battery cell can be reduced. Thus, the cooling performance of the battery cell is improved.

According to an embodiment, since the side surface portion of the second plate member is unlikely to cause the stress concentration when receiving the force in the stacking direction from the battery cell, the degree of freedom in shape of the first plate member integrated with the side surface portion is increased. Therefore, it is possible to form the first plate member in which the convex portions and the concave portions are alternately provided in the stacking direction.

According to an embodiment, since the plate thickness of the first plate member is thin, a bending radius of the flow path forming portion can be reduced, and an area of the surface in contact with the side surface of the battery cell can be increased. Thus, the cooling performance of the battery cell is improved.

According to an embodiment, the cooler can be configured as a boiling cooling type.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cooler that cools a battery stack in which a plurality of battery cells are stacked, the cooler comprising:
a first plate members that is in surface contact with a side surface of the battery cells, the side surface facing a width direction orthogonal to a stacking direction of the battery cells, among surfaces of the battery cells;
a second plate members that is integrated with the first plate member and restrains the battery stack so as to prevent the battery cells from being moved in the stacking direction; and
a refrigerant flow path formed between the first plate member and the second plate member and through which a refrigerant for cooling the battery cells flows, wherein
the second plate member has a flat plate-shaped side surface portion extending in the stacking direction and extending in a vertical direction orthogonal to the stacking direction, and
battery cells arranged at both ends in the stacking direction among the plurality of battery cells or end plates arranged at both ends in the stacking direction of the battery stack are fixed to the second plate member.

2. The cooler according to claim 1, wherein
the second plate member includes:
an upper flange portion extending inward in the width direction from an upper portion of the side surface portion and disposed to face an upper surface of the battery cells; and
a lower flange portion extending inward in the width direction from a lower portion of the side surface portion and disposed to face a lower surface of the battery cells, wherein
the battery cells arranged at both ends in the stacking direction among the plurality of battery cells or the end plates arranged at both ends in the stacking direction of the battery stack are fixed to the upper flange portion, and
the battery cells are fixed to the lower flange portion when the battery cells are fixed to the upper flange portion, and the end plates are fixed to the lower flange portion when the end plates are fixed to the upper flange portion.

3. The cooler according to claim 1, wherein
a plate thickness of the first plate member is greater than a plate thickness of the second plate member.

4. The cooler according to claim 3, wherein
the first plate member is provided with convex portions and concave portions alternately in the stacking direction at a portion facing a side surface of the battery stack.

5. The cooler according to claim 3, wherein
the first plate member includes:
a flat plate portion that is in surface contact with the side surface portion of the second plate member; and
a flow path forming portion that protrudes from the flat plate portion toward the battery cell and forms the refrigerant flow path between the first plate member and the side surface portion of the second plate member, wherein
a surface of the flow path forming portion is in surface contact with a side surface of the battery cell.

6. The cooler according to claim 1, wherein
the refrigerant is a working fluid that undergoes a phase change between a liquid phase and a gas phase, and
the refrigerant flow path constitutes an evaporation flow path in which the working fluid in the liquid phase is vaporized by receiving heat of the battery cell.
